(19) United States
(12) Patent Application Publication
(10) Pub. No.: US 2007/0065117 A1
(43) Pub. Date: Mar. 22, 2007

(54) Digital video camera capable of recognizing incorporated recording medium by external unit

(75) Inventors: Tatsuhiko Ikehata, Ome-shi (JP); Tatsuro Abe, Ome-shi (JP); Kei Tashiro, Ome-shi (JP); Toyokazu Aizawa, Sagamihara-shi (JP); Tsuyoshi Hagiwara, Ome-shi (JP); Shiro Nagaoka, Ome-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/517,450

(22) Filed: Sep. 8, 2006

(30) Foreign Application Priority Data
Sep. 16, 2005 (JP) 2005-270885

(51) Int. Cl. H04N 5/00

(52) U.S. Cl. 386/117

(57) ABSTRACT

An embodiment of the invention is to record a predetermined information on a recording medium by connecting to a predetermined interface, so that an image signal held on a recording medium is readable from an external storage unit provided separately from the recording medium, and the recording medium is recognizable, when displaying a digital video camera in a list of recording media in an image recording/processing unit that is an external unit when viewed from the digital video camera, in order to provide a digital video camera, in which a recording medium itself included in the digital video camera is recognizable by an image recording/processing unit.

### CROSS-REFERENCE TO RELATED APPLICATIONS

This application is based upon and claims the benefit of priority from Japanese Patent Application No. 2005-270885, filed Sep. 16, 2005, the entire contents of which are incorporated herein by reference.

### BACKGROUND

1. Field

The present invention relates to a portable video recording apparatus, and in particular to a digital video camera using a large-capacity non-tape recording medium.

2. Description of the Related Art

A digital video camera capable of recording a moving image on a non-tape recording medium, such as a memory card (a semiconductor memory) or a hard disc drive having an extended recording capacity, has achieved widespread use.

A digital video camera is equipped with a rewritable storage unit, and image information held in the storage unit can be read with an image editor prepared outside.

For example, Japanese Patent Application Publication (KOKAI) No. 2000-358037 discloses a management apparatus, which can optionally input and register the user's name for each unit existing on a data bus.

As the storage capacity of an image editor prepared outside has increased, the price of a storage unit connectable to the image editor has faller, and the number of units connectable at a time has been increased, it is demanded to easily specify a storage unit as a pre-step of recognizing the image information and image file held in the storage unit.

There are following methods in the prior art, but all methods are inconvenient for the reasons described below.

1) Display of a list similar to an embodiment of the present invention is possible by a process of maintaining a program for monitoring connection of a drive (medium), and changing an icon of a drive by the monitoring program when the program detects that a specific unit is connected. However, an icon cannot be changed for a unit not having a resident monitoring program, and it is necessary to provide a monitoring program in all units used by the user.

2) Display of a list similar to an embodiment of the present invention is possible by a process of Previously changing an icon of a specific drive. However, it is necessary to set an icon in all units used by the user, and to reset each time a registered drive number is changed.

3) Display of a list similar to an embodiment of the present invention is possible by a process of changing an icon by the user's operation of writing “AUTORUN.INF” and “ICON” files in a recording medium. However, if the files written on the recording medium are lost by formatting or erasing, it is necessary to reset the files.

Further, it is difficult to solve all the above problems even by the apparatus described in the above-mentioned document.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of connection between a camera and an external image recording/processing unit connected to a network in accordance with an embodiment of the invention;

FIG. 2 is an exemplary diagram showing an example of a cradle used for connection between the camera and external image recording/processing unit shown in FIG. 1 in accordance with an embodiment of the invention;

FIGS. 3A and 3B are exemplary diagrams showing an example of a digital video camera capable of recording a still image, a moving image and an audio signal, in according to an embodiment of the invention;

FIG. 4 is an exemplary diagram explaining a method of setting “AUTORUN.INF” in the camera shown in FIGS. 3A and 3B in accordance with an embodiment of the invention;

FIG. 5 an exemplary flowchart explaining a method of setting “AUTORUN.INF” in the camera shown in FIGS. 3A and 3B, in the connections of the camera of FIGS. 3A and 3B shown in FIGS. 1 and 2 in accordance with an embodiment of the invention;

FIG. 6 is an exemplary diagram showing an example of a list of removable storage devices displayed on an external image recording/processing unit by using the icons already set in the camera shown in FIGS. 3A and 3B by “AUTORUN.INF”, in the connection of the camera of FIGS. 3A and 3B shown in FIGS. 1 and 2 in accordance with an embodiment of the invention; and

FIG. 7 is an exemplary diagram showing an example of a list of removable storage devices displayed in an external image recording/processing unit by an ordinary method of displaying a list different from in accordance with an embodiment of the invention.

### DETAILED DESCRIPTION

Various embodiments according to the invention will be described hereinafter with reference to the accompanying drawings. In general, according to one embodiment of the invention, a digital video camera comprising: a photoelectric conversion element which converts a moving image taken through a lens, into an image signal; a recording medium which holds the image signal output from the photoelectric conversion element; an image signal processor which converts the image signal output from the photoelectric conversion element, to a signal format recordable on the recording medium, and records the signal on the recording medium; an expansion connector which supplies the image signal held on the recording medium, to an external recording unit provided separately from the recording medium; and an information control unit which is provided removably from the expansion connector of the camera, and when connected to the expansion connector, records a predetermined information on the recording medium, in the state that an expansion connecting unit configured to output the image signal to the external recording unit is being connected to the expansion connector, so that the recording medium is recognizable in the external recording unit.

Hereinafter, embodiments of the invention will be explained in detail with reference to the accompanying drawings. A digital video camera having a memory card (a semiconductor memory) and a hard disc drive with an extended recording capacity will be explained as an example.

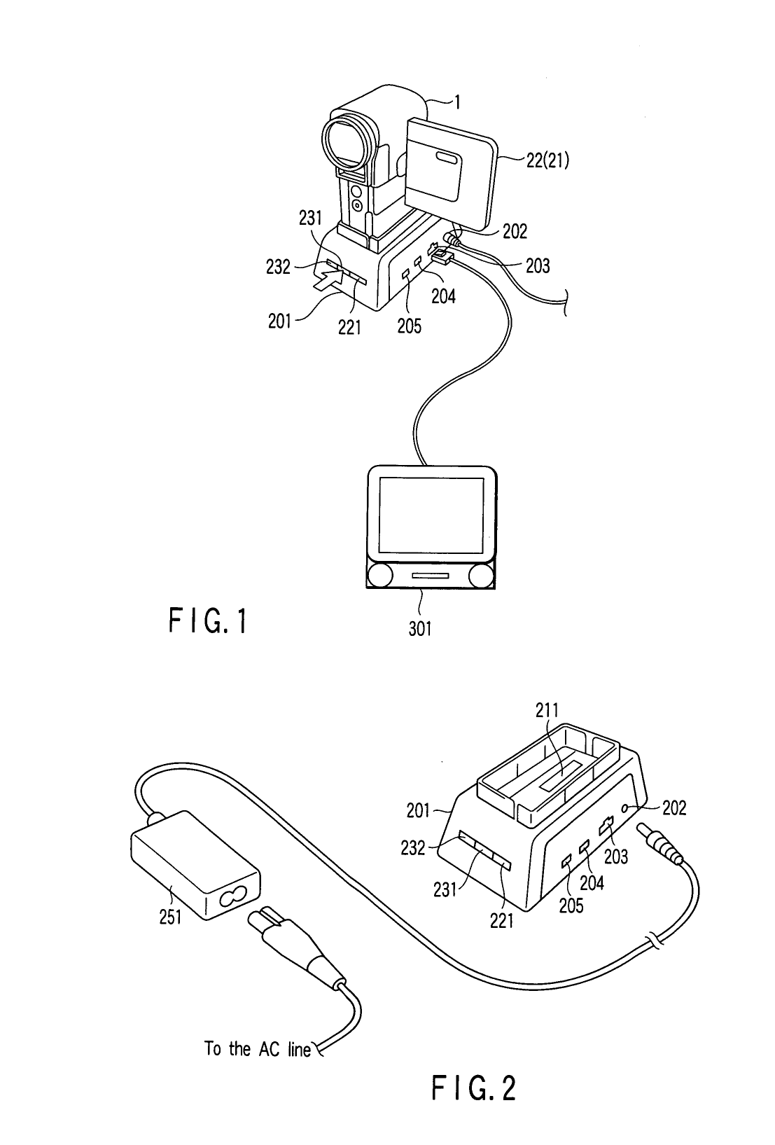

FIG. 1 is a schematic diagram showing the state that a digital video camera 1 is connected to a personal computer (PC) 301 as an image information recording/processing unit, through a local area network (LAN) or Universal Serial Bus (USB). The digital video camera 1 is mounted on a cradle 201 as an expansion unit to enable connection with the personal computer 301 through the USB.

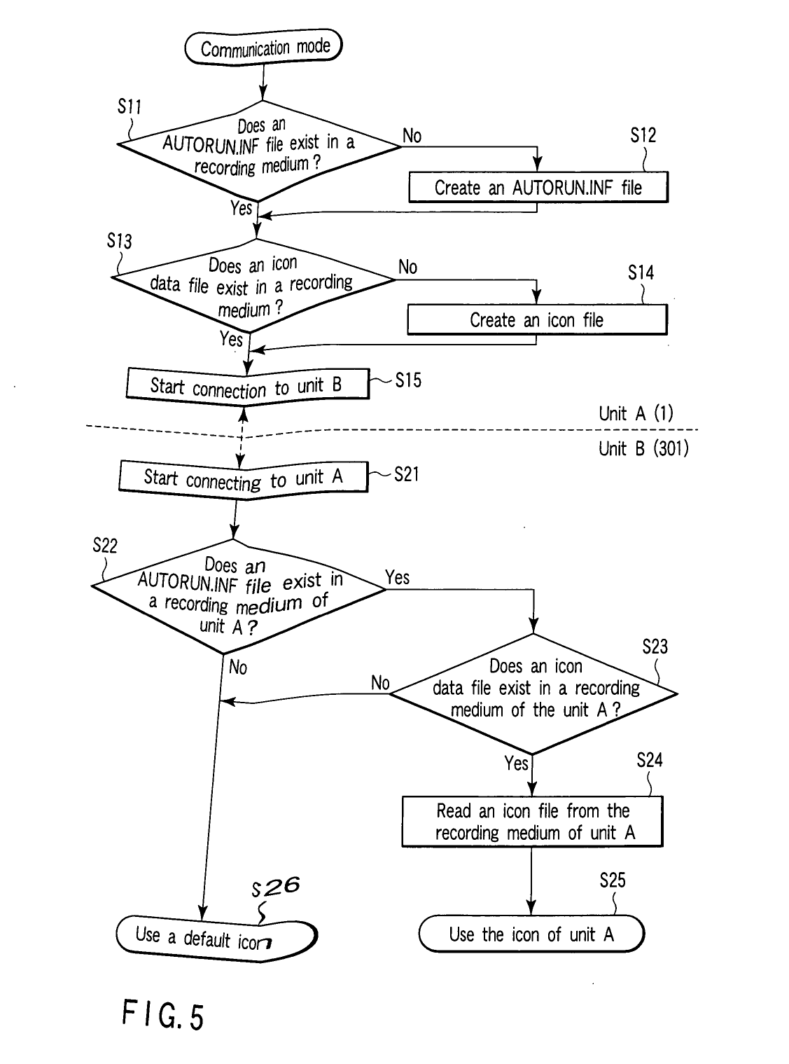

The personal computer 301 connected to the digital video camera 1 displays, as a screen explained later with reference to FIG. 5, a removable storage device display area 301-1 capable of displaying a list of devices which have a removable storage area and are incorporated in the personal computer 301 or connected (to the personal computer) through the USB, and a hard disc drive display area 301-2 capable of displaying a list of hard disc drives prepared within the personal computer 301.

The devices displayed in the removable storage device display area 301-1 on the screen of the personal computer 301 includes, in addition to the devices connected through the USB, an expansion memory such as a memory stick or a PC card capable of directly transferring data, a semiconductor memory or a magneto-optical (MO) disc capable of reading and writing data in/from the personal computer 301 through a well-known LAN, and an optical disc drive previously incorporated in the personal computer (capable of reading and writing data in/from an optical disc set in a DVD drive or a CD drive).

The personal computer (PC) 301 must use Microsoft Windows XP as the operating system (OS).

When using Windows XP in the PC 301, it is Possible to set a file “AUTORUN.INF” indicating an automatic start for a drive, or a recording medium.

Therefore, if a file name of an icon corresponding to an object recording medium is previously specified in this file, the icon of the preset file name can be displayed in the digital camera 1 at the time when the connection of that recording medium or drive is confirmed, when displaying the icon in the display area 301-1 on the above-mentioned screen.

An SD memory (SD card) and a mini-SD (registered trademark) used widely can be used as a single device or in the state being set in the digital video camera 1 as described above. Therefore, in the prior art, when perusing the removable storage devices connected to the PC 301 from the PC 301 side, the user is required to access each device and confirm (open) the file in that medium for identifying (specifying) the card memory (medium) set as a device in the digital video camera 1.

Therefore, if there is a possibility of reading or editing image data from the PC using Windows XP as OC, it is possible to reduce the time to specify a file when reading or editing image data from the PC 301, by setting (writing) “AUTO.INF” on a recording medium, in a drive handling an object recording medium (capable of transferring data), that is, the digital Video camera 1 of the embodiment, under the specific conditions such that a memory card is set by the user or a main power is turned on. In the embodiment, “AUTORUN.INF” is written whenever the main power of the digital video camera 1 is turned on.

FIG. 2 is a schematic diagram of a camera fixing unit (a cradle), or a connection medium facilitating connection of the digital video camera 1 to the personal computer, when connecting the personal computer and digital video camera shown in FIG. 1 through a LAN.

A cradle 201 serves as a data transfer unit, which permits the digital video camera 1 to transfer image data and a folder (album) containing a plurality of image data under a predetermined condition, to a recording/reproducing apparatus containing a hard disc connectable to a not-shown TV receiver and a monitor unit.

The cradle 201 is provided with a power supply terminal 202 to receive a DC output from an AC adapter 251 which converts an AC voltage from a commercial power line to 5 V DC suitable for operating the camera 1, a LAN terminal 203 used for connection with a LAN, and a USB terminal 204, and an A/V output terminal 205 used to directly input an analog audio signal and a video signal to a TV receiver or a monitor unit.

The terminals 202-205 are connected to a contact 211 provided at a predetermined position inside the cradle 201, so that they can be electrically connected to an adapter connector 15 of the camera 1.

The cradle 201 is also provided with a power button (a power switch) 221, which can be set to supply or shut off 5 V DC to the digital video camera 1 mounted on the cradle 201 in the state that the AC adapter 251 is being connected to a not-shown commercial power line. The power button 221 is a switch containing an LED element, although not described in detail. When the switch is pressed (turned on), a predetermined color light is emitted and the 5 V DC from the AC adapter 251 is supplied to the camera 1. When the switch is pressed again, the light is not emitted and the 5 V DC is shut off.

The cradle 201 is also provided with a LAN button (a LAN switch) 231 used for switching the connection to a router (a hub) that is connected to the LAN terminal 203 through a LAN cable, and a USB button (a USB switch) 232 used for switching the connection to a personal computer or an external storage unit (an external HDD drive or a USB memory) that is connected to the USB terminal 204 through a USB cable. The LAN button 231 and USB button 232 are selective switches, that is, when one is turned on (in the pressed state), the other is turned off. Although not described in detail, each button has a built-in LED, and the LED corresponding to the button selected (pressed) now is lit.

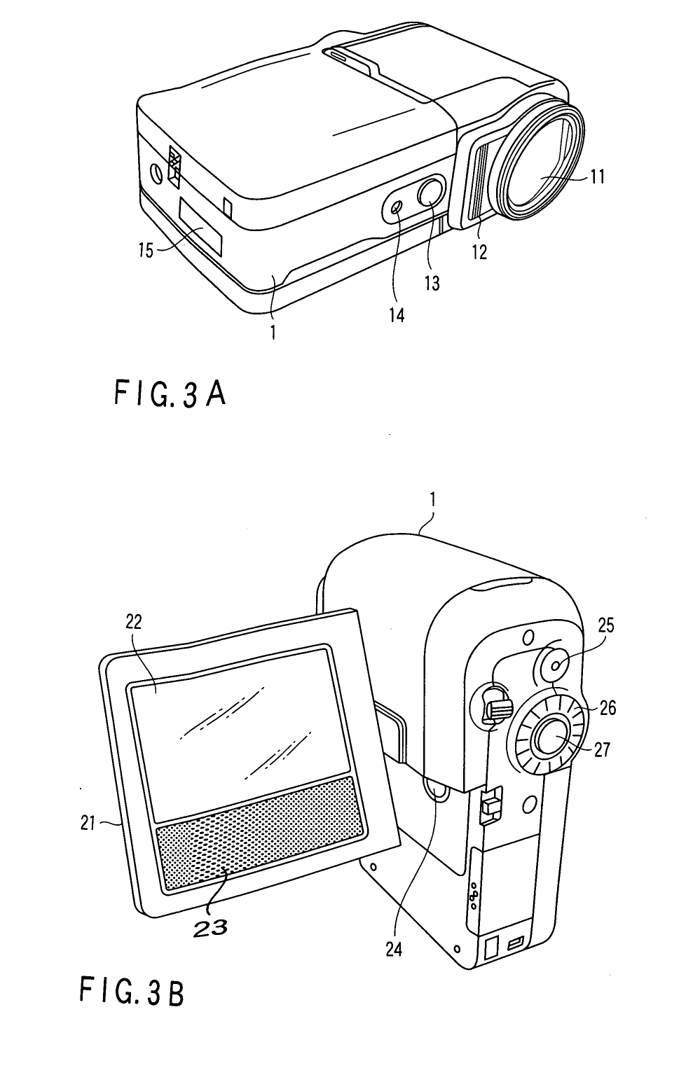

FIGS. 3A and 3B are schematic diagrams showing a digital video camera capable of recording a still image, a moving image and an audio signal, according to the invention explained with reference to FIG. 1.

FIG. 3A shows a digital video camera (an image pickup unit) 1 viewed from the pickup lens side.

The digital video camera 1 has an image pickup lens 11, a flash 12, a shutter button 13 (for taking a still image), and a remote control receiver 14. The digital video camera 1 also has an adapter connector (a connection terminal) 15 used to connect a personal computer, an external power supply (a charger), etc.

FIG. 3B shows a digital video 1 viewed from the side reverse to the pickup lens 11.

The digital video camera 1 has a liquid crystal monitor (an LCD panel) 22 and a speaker 23, which are provided as one body with a frame 21 serving as a main power switch. The digital video camera 1 also has a main power switch 24 at a predetermined position that is turned off when the frame 21 is closed (contained in a predetermined position of the main body of the digital video camera).

The digital video camera 1 also has, at a predetermined position, a recording button 25 capable of inputting instructions (control commands) to start and stop (end) recording of a moving image, a jog dial 26 capable of inputting instructions (control commands) to input and decide operation mode and various conditions, and an OK button 27 capable of inputting an instruction (a control command) to set (execute) the instruction selected (guided) by the job dial 26. The OK button 27 is provided concentrically with the center of rotation of the jog dial 26, for example.

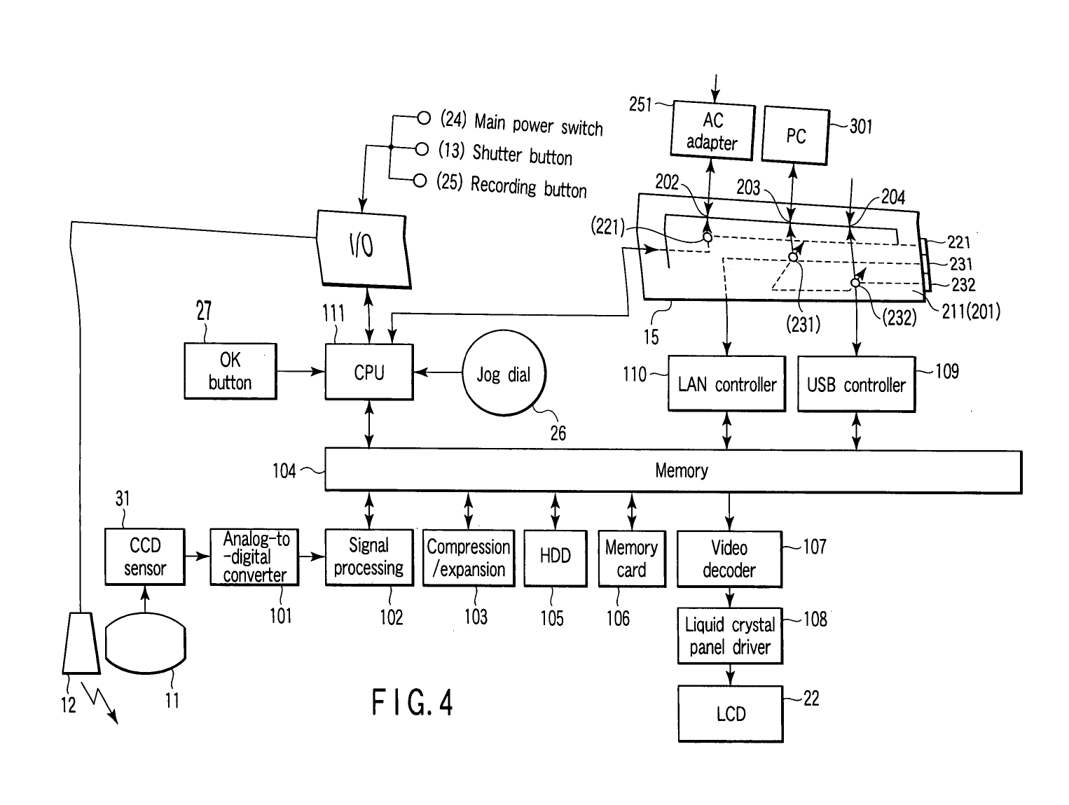

FIG. 4 shows an example of a control block of the digital video camera shown schematically in FIGS. 3A and 3B.

An image of a subject taken in through the image pickup lens 11 forms an image on the image forming surface of the image pickup element 31, or a CCD sensor, for example, and is converted into an analog signal (a pickup image data).

The analog signal (pickup image data) from the CCD sensor 31 is converted to a digital signal in an analog-to-digital converter 101 controlled by a CPU (a main control circuit) 1, and input to a camera signal processing circuit 102.

The camera signal processing circuit 102 performs gamma correction, color signal separation, or white balance adjustment, for example, for the pickup image data converted into a digital signal by the analog-to-digital converter 101.

The pickup image data output from the camera signal processing circuit 102, or the recording object image taken in through the pickup lens 11, is input to a liquid crystal panel driver (an LCD driver) 108 through a video decoder 107, and displayed on an LCD panel (hereinafter called simply an LCD) 22 mounted on the frame 21 (refer to FIG. 3B and FIG. 1).

The pickup image data output from the camera signal processor 102 is compressed by a compression/expansion unit 103, when recording, and recorded in a hard disc drive (hereinafter called an HDD) 105 or an attached removable recording medium, such as a nonvolatile memory, for example, a memory card 106. In the compression/expansion unit 103, a still image is compressed by a well-known compressing method, for example, the JPEG standard, and a moving image (non-still image) is compressed by MPEG standard.

As the memory card 106, a semiconductor memory called a SD card (registered trademark) and a mini-SD (registered trademark), for example, can be used.

When playing the images already recorded in the memory card 106, the image read from the HDD 105 or the memory card 106 is expanded in the image compression/expansion unit 103, and supplied to the video decoder 107 through the memory circuit 104. The image data supplied to the video decoder 107 is displayed in the LCD 22 through the liquid crystal panel driver 108.

A not-shown recording media interface is used for transfer of data (compressed image) between the HDD 105 and memory card 106. Of course, an optical disc may be used, instead of the HDD 105. It is also Possible to use a memory card (1067) with a large capacity as a main recording medium. The memory card 106 can also be connected through a card slot incorporated as one body with the PC 301, or a reader/writer capable of transferring data to the recording media connected to the PC 301, thereby image data can be read and written.

Each time the main power switch 24 of the digital video camera 1 is turned on, “AUTORUN.INF” is set (written) in the HDD 105 and memory card 106. The memory card 106 is, of course, inserted into a not-shown memory card slot, when recording an image. But, when the residual recording capacity runs out while image data is being recorded through the digital video camera 1, the memory card may be removed from the memory card slot and replaced by an unused memory card, if necessary. Therefore, each time the memory card is set in the digital video camera 1, “AUTORUN.INF” may be written according to the results of checking the presence of a “AUTORUN.INF” file.

The image data of the still image or moving image recorded in the HDD 105 or memory card 106 is connected to the PC 301 through the cradle 201 (refer to FIG. 2) connected to the adapter connector 15, as briefly explained in FIG. 1. A USB can be used, as well as a LAN, for the connection with the PC 301, in the case of one-to-one connection when viewed from the camera 1. Similarly, as an interface, various well-known standards, for example, IEEE 1394, and a parallel bus can be used.

An interface controller 109 is interposed between an Optional interface and the memory circuit 104. A LAN controller 110 is used for data transfer by using a router 301.

FIG. 5 is a flowchart explaining a method of setting “AUTORUN.INF” of the embodiment explained briefly in FIG. 1 and FIG. 2.

As shown in FIG. 5, when the PC 301 (unit B) and digital video camera 1 (unit A) are connected through the cradle 201, whether an “AUTORUN.INF” file exists in a recording medium (the memory card 106 or HDD 105, or the both) is checked in the digital video camera 1 (unit A) (S11).

If an “AUTORUN.INF” file is not found (S11-NO), an “AUTORUN.INF” file is created (S12).

If an “AUTORUN.INF” file is found in step S11 (S11-YES), whether an icon data file exists in a recording medium is checked (S13).

If an icon data file is not found (S13-NO), an icon data file is created (S14).

In contrast, whether an “AUTORUN.INF” file exists in a recording medium (the memory card 106 or HDD 105, or the both) contained in the digital video camera 1 (the unit A) is checked in the PC 301 (unit B) (S22).

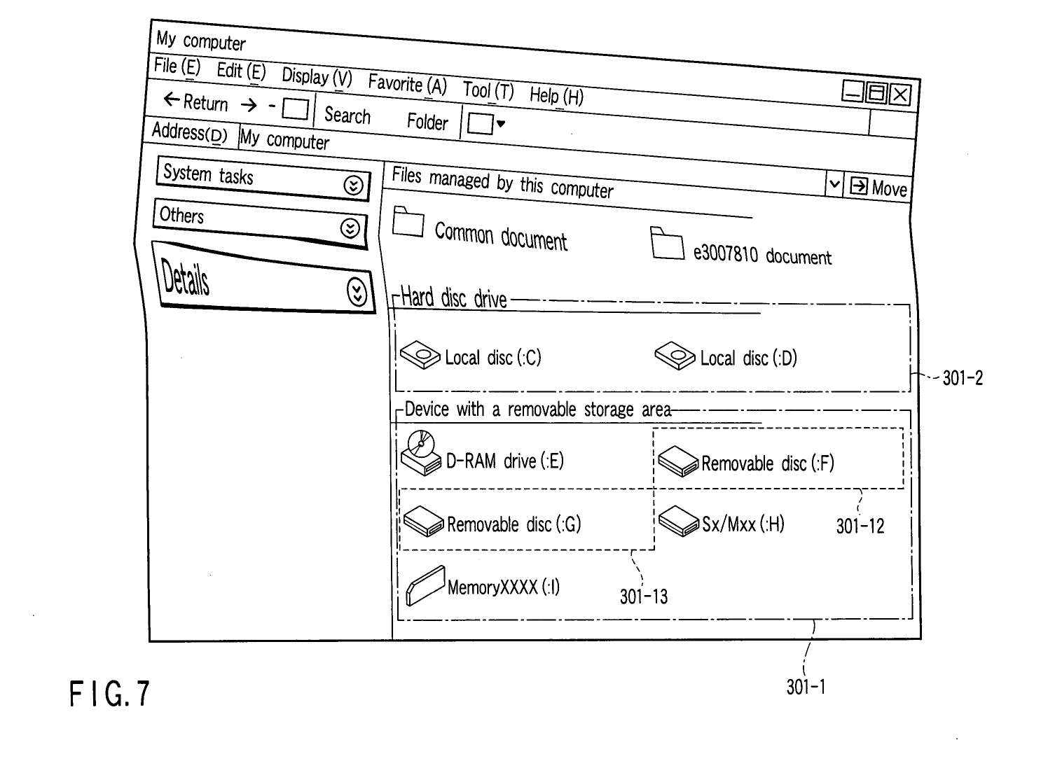

If an “AUTORUN.INF” file is not found in the camera 1 (unit A) in step S22 (S22-NO), a list of devices is displayed, by the (default) icons previously prepared in the PC 301 (refer to the display 301-11/12), as the icons of the devices to be displayed in the removable storage device display area 301-1 on the screen of the PC 301 (the unit B), as shown in FIG. 7.

If an “AUTORUN.INF” file is found in the camera 1 (unit A) in step S22 (S22-YES), whether an icon data file exists in a recording medium (of the unit A) is checked (S23).

If an icon file is found in the unit A in step S23 (S23-YES), the data of the icon file is taken in from the recording medium in the unit A (the icon file held by the unit A is read by the unit B (PC 301) (S24).

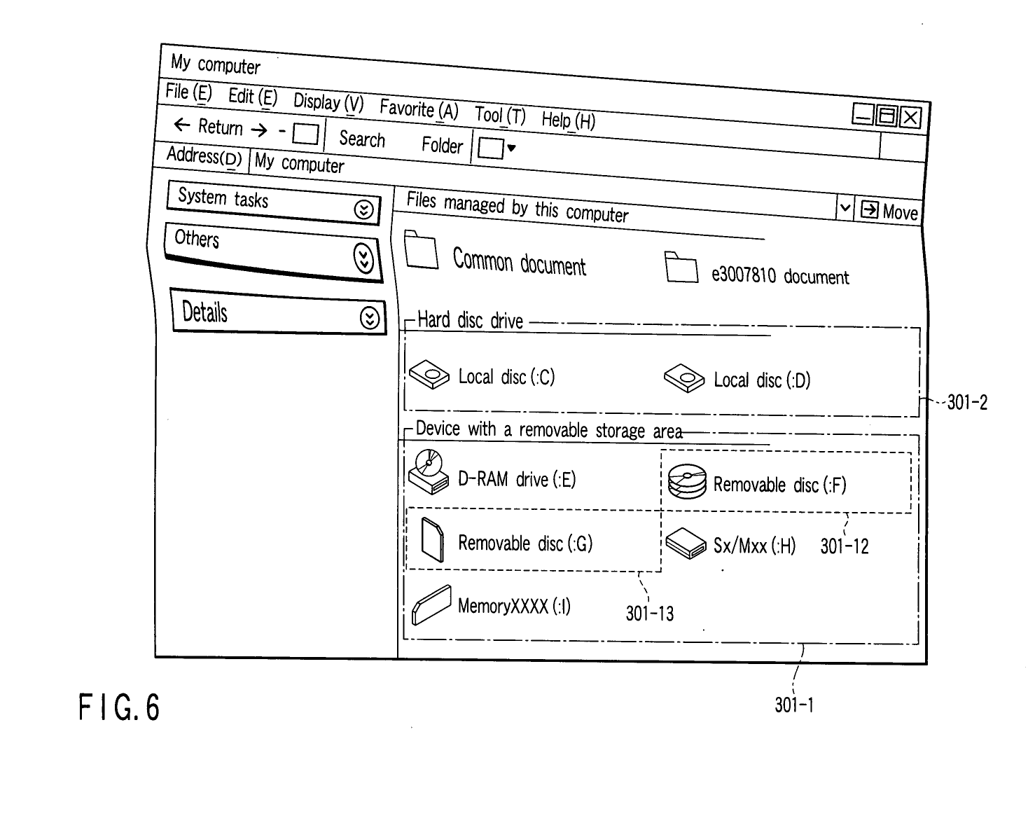

When the icon file prepared in the unit A (camera 1) is read in step S24, a list of devices is displayed, as the icons of the devices to be displayed in the removable storage device display area 301-1 on the screen of the PC 301 (the unit B), by the icons previously prepared in the unit A, or the digital video camera 1, (the (original) icons peculiar to the digital video camera 1) or by the icons previously set in the digital video camera 1 (refer to the display 301-11/12), as shown in FIG. 6. As seen from the FIG. 6, the display 301-11 displayed in the display area 301-1 is easily recognized as an HDD, and the display 301-12 is easily recognized as an SD card. Therefore, when a plurality of recording medium (individual medium) exists, they can be easily recognized.

As described above, it is possible to easily recognize (specify) a recording medium held in the digital video camera 1 when the digital video camera 1 is connected to the PC 301, by displaying the icons previously prepared in or peculiar to the video camera 1 in the removable storage device display area 301-1 capable of displaying a list of the devices which are incorporated in the personal computer 301, or connected to (the personal computer) through the LAN, and have a removable storage area, in the personal computer 301 connected to the digital video camera 1. Therefore, the user is unnecessary to access each device, and confirm (open) the file in the recording medium in that device. This increases the efficiency of arranging an image file and editing (an optional image file), and decrease the possibility of accidentally erasing the pickup data.

Namely, an individual medium can be easily recognized by displaying an icon easily recognizing that a medium connected to a personal computer (PC) is a digital video camera in the personal computer, when displaying a digital video camera in a list of recording media (removable recording media) in the personal computer that is an external image recording/processing unit when viewed from the digital video camera.

Further, according to the embodiment, even if there are two or more media connected to a personal computer, they can be easily recognized.

Further, as a recognizing medium (a digital video camera) is an icon data supplying source, it is possible to provide icons easy for the user to recognize by the kinds of device and recording medium.

As described here, according to an embodiment of the invention, there is provided a digital video camera which can select whether to save a moving image file by dividing or to save collectively in one file, and is useful for arranging a moving image file, when recording a moving image, that is, when an individual medium can be easily recognized by displaying an icon easily recognizing that a medium connected to a personal computer (PC) is a digital video camera in the personal computer, when displaying a digital video camera in a list of recording media (removable recording media) in the personal computer that is an external image recording/processing unit when viewed from the digital video camera. When a moving image file has been saved in being divided, an object moving image file can be easily accessed and played quickly from an object chapter. This decreases the power consumption, which is particularly important for a portable digital video camera.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A digital video camera comprising:
a photoelectric conversion element which converts a moving image taken through a lens, into an image signal;
a recording medium which holds the image signal output from the photoelectric conversion element;
an image signal processor which converts the image signal output from the photoelectric conversion element, to a signal format recordable on the recording medium, and records the signal on the recording medium;
an expansion connector which supplies the image signal held on the recording medium, to an external recording unit provided separately from the recording medium; and
an information control unit which is provided removably from the expansion connector of the camera, and when connected to the expansion connector, records a predetermined information on the recording medium, in the state that an expansion connecting unit configured to output the image signal to the external recording unit is being connected to the expansion connector, so that the recording medium is recognizable in the external recording unit.

2. The digital video camera according to claim 1, wherein when the recording medium exists in two or more number, the information control unit records a predetermined information to recognize each recording medium.

3. The digital video camera according to claim 1, wherein whenever a main power supply is turned on, the information control unit records a predetermined information to recognize the recording media on the recording medium.

4. The digital video camera according to claim 1, wherein the predetermined information usable to recognize the recording media is held in the information control unit or a memory connected to the information control unit, so as to be read by the information control unit.

5. The digital video camera according to claim 1, wherein the predetermined information usable to recognize the recording media is readable by the external recording unit, when connected to the expansion connecting unit provided removably from the extension connector.

6. A digital video camera comprising:
a photoelectric conversion element which converts a moving image taken through a lens, into an image signal;
a recording medium which holds the image signal output from the photoelectric conversion element;
an image signal processor which converts the image signal output from the photoelectric conversion element, to a signal format recordable on the recording medium, and records the signal on the recording medium; and
an information control unit which records a predetermined information on the recording medium, when connected to a USB, so as to be suppliable to an external recording unit provided separately from the recording medium, and so that the recording medium is recognizable from the external recording unit.

7. The digital video camera according to claim 6, wherein when the recording medium exists in two or more number, the information control unit records a predetermined information to recognize each recording medium.

8. The digital video camera according to claim 6, wherein whenever a main power supply is turned on, the information control unit records a predetermined information to recognize the recording media on the recording medium.

9. The digital video camera according to claim 6, wherein the predetermined information usable to recognize the recording media is held in the information control unit or a memory connected to the information control unit, so as to be read by the information control unit.
